(19) United States
(12) Patent Application Publication
(10) Pub. No.: US 2025/0106548 A1
(43) Pub. Date: Mar. 27, 2025

(54) ELECTRONIC APPARATUS

(71) Applicant: CASIO COMPUTER CO., LTD., Tokyo (JP)

(72) Inventors: Hiroki AKAI, Tokyo (JP); So SATO, Tokyo (JP)

(21) Appl. No.: 18/894,548

(22) Filed: Sep. 24, 2024

(30) Foreign Application Priority Data
Sep. 25, 2023 (JP) 2023-159428

(51) Int. Cl. H04R 1/26; G10C 3/02

(52) U.S. Cl. CPC H04R 1/26; G10C 3/02

(57) ABSTRACT

Electronic apparatus includes a housing, a first sound-emitting component provided at a first side in a left-right direction of the housing and having multiple sound-emitting elements whose main sound-emitting directions differ from each other, and a second sound-emitting component provided at a second side in the left-right direction of the housing and having multiple sound-emitting elements whose main sound-emitting directions differ from each other.

### CROSS-REFERENCE TO RELATED APPLICATION

This application is based upon and claims the benefit of priority under 35 USC 119 of Japanese Patent Application No. 2023-159428 filed on Sep. 25, 2023, the entire disclosure of which, including the specification, claims, drawings and abstract, is incorporated herein by reference in its entirety.

### BACKGROUND

### Technical Field

The present disclosure relates to an electronic apparatus.

### Description of the Related Art

Conventionally, electronic apparatuses equipped with multiple speakers have been known. For example, Japanese Unexamined Patent Application Publication No. 9-212167 (JP-A-9-212167) discloses an electronic keyboard instrument including a main speaker for a high-pitched sound range and a main speaker for mid-pitched and low-pitched sound ranges. In this electronic keyboard instrument, the main speaker for the high-pitched sound range and the main speaker for the mid-pitched and low-pitched sound ranges are provided in such a manner as to be aligned parallel to each other in a left-right direction.

### SUMMARY

According to an aspect of the present disclosure, there is provided an electronic apparatus including a housing, a first sound-emitting component provided at a first side in a left-right direction of the housing and having multiple sound-emitting elements whose main sound-emitting directions differ from each other, and a second sound-emitting component provided at a second side in the left-right direction of the housing and having multiple sound-emitting elements whose main sound-emitting directions differ from each other.

### BRIEF DESCRIPTION OF THE DRAWINGS

FIG. 1 is a frontal overall perspective view of an electronic keyboard instrument according to an embodiment of the present disclosure;

FIG. 2 is a sectional view of a main body part of the electronic keyboard instrument according to the embodiment, which is a sectional view taken along a line II-II in FIG. 1;

FIG. 3 is a bottom view of the electronic keyboard instrument according to the embodiment when viewed from a lower side, showing a front top plate, a cover plate, a perforated plate, and tweeter pairs thereof;

FIG. 4 is a top view of the main body part of the electronic keyboard instrument according to the embodiment with the front top plate, a back top plate, and the cover plate removed;

FIG. 5 is a perspective view of a tweeter pair and its vicinity at one side or a first side of the electronic keyboard instrument according to the embodiment when viewed from a back side and the lower side;

FIG. 6 is a side sectional view of the main body part of the electronic keyboard instrument according to the embodiment, which is a sectional view taken along a line VI-VI in FIG. 4;

FIG. 7 is a top view of the tweeter pair at one side of the electronic keyboard instrument according to the embodiment when viewed from above; and

FIG. 8 is a side view of the tweeter pair at one side of the electronic keyboard instrument according to the embodiment when viewed obliquely rightwards from a front side.

### DESCRIPTION OF THE EMBODIMENT

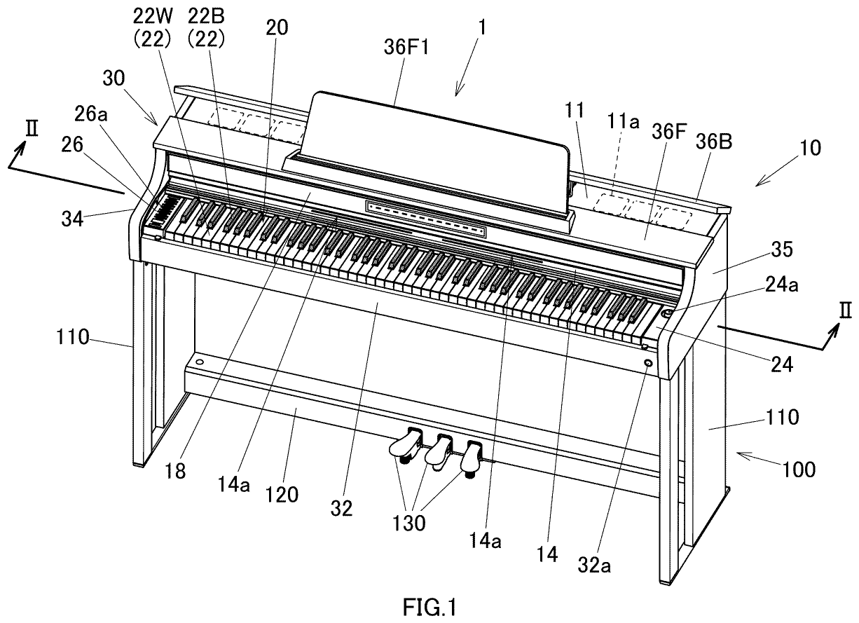

Referring to drawings, an embodiment of the present disclosure will be described. An electronic keyboard instrument (an electronic apparatus) 1 shown in FIG. 1 includes a control circuit made up of at least one processor, not shown, a main body part 10, and a leg part 100. As shown in FIG. 1, the main body part 10 includes a keyboard (a controller) 20 and a main body case (a housing) 30 which surrounds the keyboard 20 to hold it. The keyboard 20 has multiple keys 22 made up of white keys 22W and black keys 22B, which are provided so as to be exposed to an outside of the keyboard 20 for a player to press them when he or she plays the electronic keyboard instrument 1. The leg part 100 includes a pair of side plates 110, a pedal frame 120, and a pedal device 130. In the following description, an alignment direction of the multiple keys 22 of the keyboard 20 is referred to as a left-right direction (in FIG. 1, a direction towards a left side is referred to as a leftward direction), an extending direction of each key 22 is referred to as a front-back direction (in FIG. 1, a direction towards a nearer side is referred to as a front direction), and an up-down direction of the electronic keyboard instrument 1 is referred to as an up-down direction (in FIG. 1, a direction towards an upper side is referred to as an upward direction).

As shown in FIG. 1, the pair of side plates 110 are plates which are erected on a setting surface on both left and right sides of the electronic keyboard instrument 1 in such a way that both plate surfaces of each plate are directed in the left-right direction so as to support the main body part 10 or the main body case 30. The pedal frame 120 extends between the side plates 110 to connect them together at lower sides of the side plates 110. The pedal device 130 is provided at a substantially central portion of the pedal frame 120 in the left-right direction. In the electronic keyboard instrument 1, the main body case 30 of the main body part 10 which is exposed to an outside of the electronic keyboard instrument 1 and both the side plates 110 of the leg part 100 are all made of wood, which characterizes the quality of the electronic keyboard instrument 1. Hereinafter, the configuration of the main body part 10 will be described in detail.

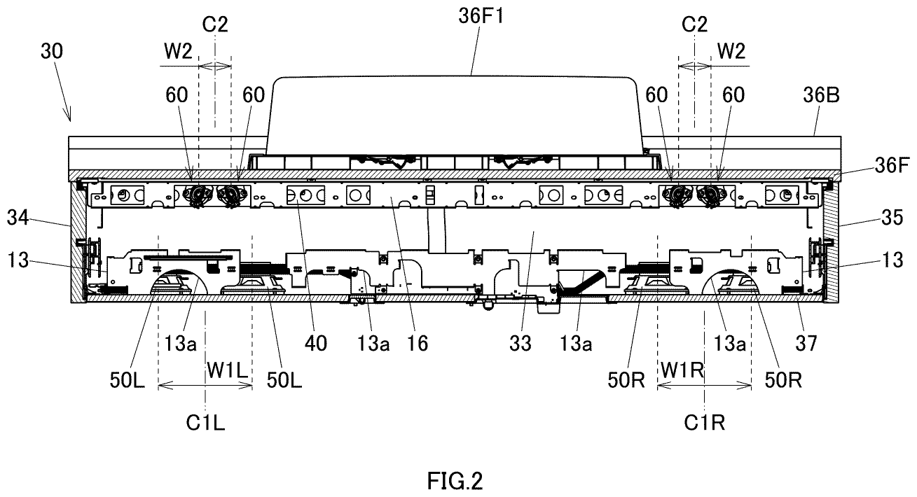

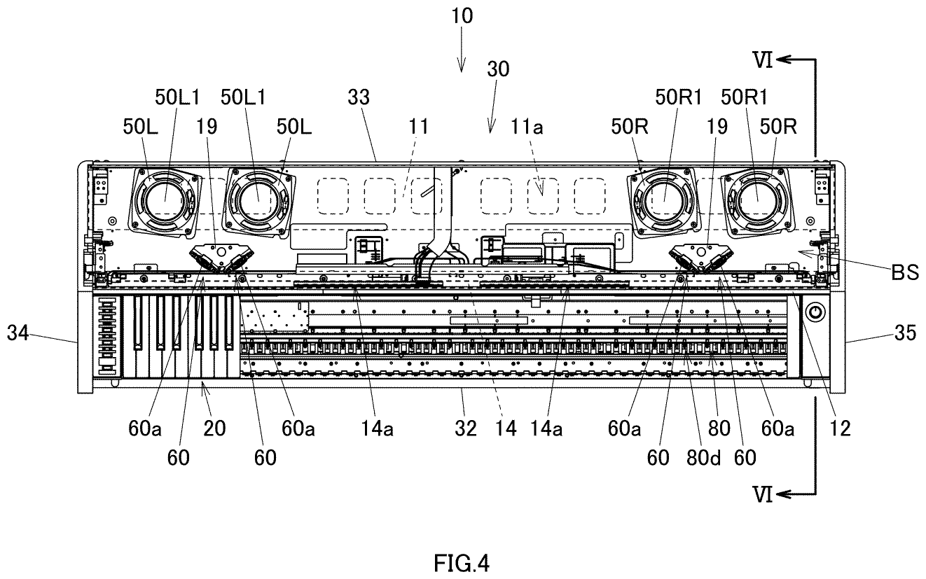

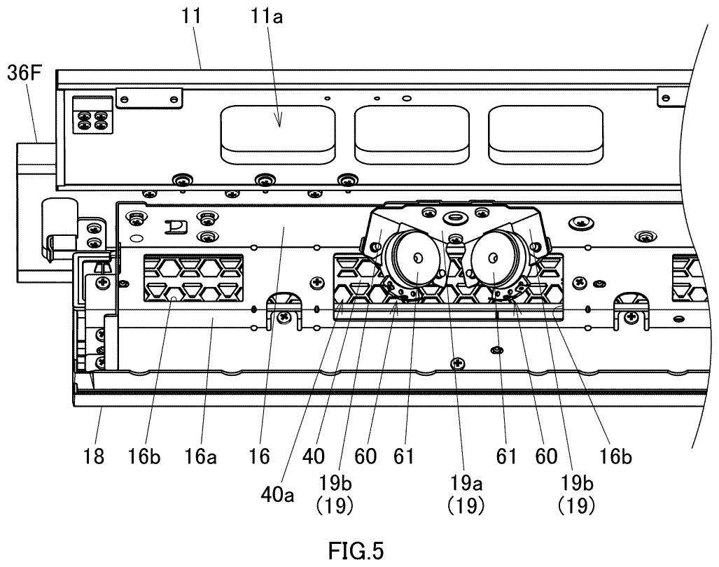

As shown in FIGS. 1 to 5, when viewed from an upper side and a lower side thereof, the main body case 30 has a substantially rectangular shape which is elongated laterally in such a way that a longitudinal direction thereof follows the left-right direction. Then, the main body case 30 has thick plates including a front plate 32, a back plate 33, a left side plate 34, a right side plate 35, a front top plate 36F, a back top plate 36B, and a lower plate 37. In addition, the main body case 30 has a vertical section of a substantially L-shape (refer to FIG. 5) when viewed from a left side thereof. Here, in FIG. 2, the main body case 30 is shown being in a state in which the back plate 33 is removed (or omitted) when viewed from a back side, and in FIG. 4, the main body case 30 is shown being in a state in which the front top plate 36F, the back top plate 36B, and a cover plate 11, which will be described later, are removed (or omitted) when viewed from an upper side. The front plate 32 has a substantially rectangular shape which is elongated in the left-right direction and is provided to be positioned at a lower portion of a front end portion of the main body part 10 and on a lower side of the keyboard 20, constituting a front surface of the main body case 30. A power button 32a is provided at a right end portion of the front plate 32 to switch on and off a main power supply (refer to FIG. 1). The back plate 33 has a substantially rectangular shape which is elongated in the left-right direction and is provided on a back side of the main body part 10, constituting a back surface of the main body case 30.

The left side plate 34 and the right side plate 35 each have a substantially rectangular shape which is elongated in the front-back direction. In each of the left side plate 34 and the right side plate 35, a step section referred to as a so-called arm plate is provided at a substantially central portion in the front-back direction so that the height of a front half portion becomes substantially equal to the height of the keyboard 20. The left side plate 34 and the right side plate 35 are provided on a left side and a right side of the main body part 10, respectively, to constitute a left side surface and a right side surface of the main body case 30, respectively. The front top plate 36F has a substantially rectangular shape which is elongated in the left-right direction and is provided on a front side of an upper backward portion of the main body part 10 to constitute a part of an upper surface of the main body case 30. The back top plate 36B has a substantially rectangular shape which is elongated in the left-right direction and is provided on a back side of the upper backward portion of the main body part 10 to constitute another part of the upper surface of the main body case 30. Here, as shown in FIGS. 1 and 4, a volume panel 24 on which a volume knob 24a and the like are disposed is provided between the keyboard 20 and the arm plate of the right side plate 35. In addition, a setting panel 26 on which various types of setting buttons 26a are disposed is provided between the keyboard 20 and the left side plate 34.

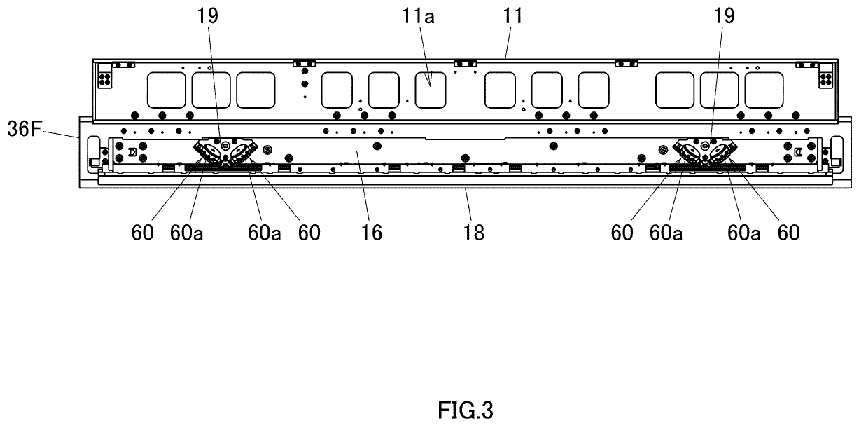

As shown in FIGS. 1, 2 and 5, the back top plate 36B is attached rotatably to the back plate 33 in such a way that the back plate 33 is opened from a front side thereof. The cover plate 11 has a substantially rectangular plate-like shape which is elongated in the left-right direction and is provided on a lower side of the back top plate 36B in such a way that both plate surfaces thereof are directed in the up-down direction. Multiple upper openings 11a are provided in the cover plate 11 in such a way as to be disposed at predetermined intervals in the left-right direction (refer to FIGS. 1 and 3). These multiple upper openings each have a substantially rectangular shape and are opened upwards from an inside of the main body case 30. An upper surface and side surfaces of the cover plate 11 are covered with a saran net. With the back top plate 36B left open, an opening below the back top plate 36B is covered by the cover plate 11, so that an interior of the main body case 30 is made invisible. In addition, a music stand 36F1 is attached to a substantially central portion of the front top plate 36F in the left-right direction. The lower plate 37 has a substantially rectangular shape which is elongated in the left-right direction and is provided on a lower side of the main body part 10 to constitute a lower surface of the main body case 30.

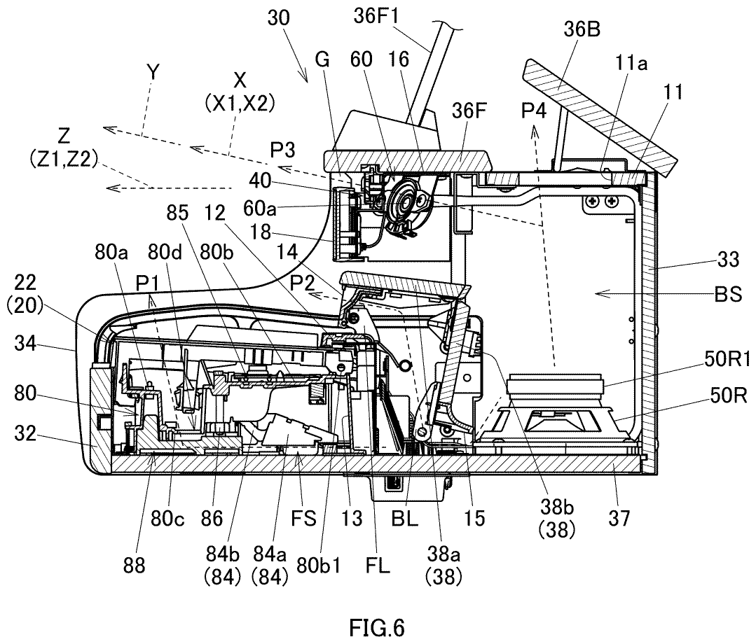

As shown in FIGS. 4 and 6, a console 12 has a substantially rectangular plate-like shape which is elongated in the left-right direction and is provided on back sides of the keys 22 of the keyboard 20 in such a way that both plate surfaces thereof are directed in the up-down direction. The console 12 is provided in a position where the console 12 overlaps with a front end portion of the front top plate 36F in the up-down direction in such a manner as to cover back end portions of the keys 22 of the keyboard 20. The console 12 prevents the interior of the main body case 30 from becoming visible via a gap at a back end portion of the keyboard 20 from an exterior of the electronic keyboard instrument 1. In addition, the keys 22 are restricted from moving in the front-back direction by the console 12 provided on the back sides of the keys 22.

As shown in FIG. 2, multiple first metallic sheets 13 are provided at a back end portion of a lower surface of the console 12 in such a way as to be disposed at predetermined intervals along the left-right direction. These multiple metallic sheets 13 each have a substantially plate-like shape and extend downwards in such a way that both sheet surfaces thereof are directed in the front-back direction. Lower end portions of the first metallic sheets 13 are attached to the lower plate 37. A back side of the keyboard 20 is fixed to the main body case 30 by the first metallic sheets 13. As shown in FIG. 6, a space defined on front sides of the first metallic sheets 13 constitutes a space provided below the keyboard 20. Multiple through holes 13a are provided individually in the lower end portions of the first metallic sheets 13 in such a way as to penetrate the first metallic sheets 13 in the front-back direction. In the interior of the main body case 30, the space defined on the front sides of the first metallic sheets 13 and a space defined on back sides of the first metallic sheets 13 are made to communicate with each other via interspaces between the multiple first metallic sheets 13 and the through holes 13a provided in the first metallic sheets 13. As a result, there is provided a structure in which sounds emitted from speakers 50R, 50L, which will be described later, are easily released from the front of the main body part 10 via the through holes 13a.

As shown in FIG. 4, in the main body case 30, a section defined between the front plate 32 and the console 12 is opened forwards and upwards, so that upper surfaces of the keys 22 of the keyboard 20 where the keys 22 are individually pressed and portions of front surfaces of the keys 22 are exposed to the outside of the keyboard 20 from this opened section. The main body part 10 includes a foldable key cover 38 for covering the section of the keyboard 20 which is exposed to the outside thereof when closed. The key cover 38 is made up of a thick plate-like component and includes a front cover section 38a and a back cover section 38b, which are each made up of a plate-like component having a substantially rectangular shape which is elongated in the left-right direction. Then, the front cover section 38a and the back cover section 38b are configured to be aligned parallel in the front-back direction when closed, whereas the front cover section 38a and the back cover section 38b are configured to be accommodated in a space defined behind the keyboard 20 while being bent when opened (refer to FIG. 6). The front cover section 38a is rotatably connected with a front link FL fixed to the main body case 30 via a front attachment 14, which is laterally elongated. Two attachment openings 14a are provided individually on a left side and a right side of a central portion (a handle section) of the front attachment 14 in the left-right direction in such a way as to be opened to penetrate the front attachment 14 in the front-back direction. These attachment openings 14a each have a substantially rectangular shape which is elongated laterally.

As shown in FIG. 6, the back cover section 38b is rotatably connected with a back link BL fixed to the main body case 30 via a laterally elongated back attachment 15. The front cover section 38a and the back cover section 38b are coupled together via a hinge in such a way as to be folded on each other and are accommodated in the space defined on the back sides of the first metallic sheets 13 in the interior of the main body case 30. Thus, the key cover 38 can freely be pulled into and out of the relevant space through a gap defined between the console 12 and a display panel 18, which will be described later. In the electronic keyboard instrument 1, when the power supply is switched off, the key cover 38 is pulled out of the interior of the main body part 10 to cover the opening, that is, the opened section of the main body case 30 where the keyboard 20 is exposed, whereby the exposed section of the keyboard 20 is designed to be covered.

In the electronic keyboard instrument 1, with the keyboard 20 covered by the key cover 38, the gap defined between the console 12 and the display panel 18 is covered by the back attachment 15. Additionally, with the key cover 38 accommodated in the space defined on the back sides of the first metallic sheets 13 after the power supply is switched on, a gap is produced between the lower plate 37 and the back attachment 15. As a result of this, with the key cover 38 accommodated accordingly, the interior of the main body case 30 is defined into a front space FS defined on a front side of the key cover 38 and a back space BS defined on a back side of the key cover 38, but the front space FS and the back space BS are allowed to communicate with each other by the gap.

As shown in FIGS. 2 and 3, a second metallic sheet 16 extends in the left-right direction and is attached to a lower surface of the front top plate 36F. As shown in FIG. 5, the second metallic sheet 16 is provided into a stair-like configuration in the up-down direction via a step section 16a. The display panel 18, which is made up of a substantially rectangular thick plate component elongated in the left-right direction, is provided on a front side of a lower section of the second metallic sheet 16 in such a way that both panel surfaces are directed in the front-back direction. The display panel 18 is provided between the front top plate 36F and the key cover 38 in a position where to define gaps between both upper and lower sides of the display panel 18 and the front top plate 36f and the key cover 38 respectively. The gaps are opened towards the front side. A gap G defined between the display panel 18 and the front top plate 36F constitutes a path through which a part of sounds from tweeters 60, which will be described later, is released to the outside of the electronic keyboard instrument 1. Most of a gap defined between the key cover 38 and the front top plate 36F is covered by the display panel 18, whereby the back space BS is made invisible. A display is provided in a front surface of the display panel 18, so that information on a play of the electronic keyboard instrument 1 is displayed on it.

A perforated component 40 is attached with screws to a front side of an upper section of the second metallic sheet 16 in such a way that both component surfaces thereof are directed in the front-back direction. The perforated component 40 is a substantially rectangular plate elongated in the left-right direction. The perforated component 40 is provided on a front side or ahead of tweeters 60, which will be described later. As shown in FIG. 5, multiple openings 16b are provided in the upper section of the second metallic sheet 16 at predetermined intervals in the left-right direction. These multiple openings 16b are opened in the front-back direction, whereby the perforated component 40 establishes a communication between a front side and a back side of the second metallic sheet 16 by way of these openings 16b. The perforated component 40 is formed of a resin through injection molding and includes multiple substantially honeycomb-shaped holes 40a which are opened from an inside towards a front side of the main body case 30 (which penetrate the perforated component 40 in a thickness direction thereof). As shown in FIG. 6, a lower portion of the perforated component 40 overlaps the display panel 18 in the front-back direction.

As shown in FIGS. 2 and 4, the electronic keyboard instrument 1 includes two pairs, that is, four sound-emitting elements or speakers (a third sound-emitting component) 50R, 50L in total, which are provided on a back side or a transversely deeper side of an upper surface of the lower plate 37 below the keyboard 20 in the back space BS with each pair disposed at one side of the lower plate 37. These speakers 50R, 50L are provided downwards and backwards of the keyboard 20 in such a way that speaker sound-emitting sections 50R1, 50L1, each having a shape of frustum of circular cone, are disposed above the lower plate 37. Sounds emitted from the speaker sound-emitting sections 50R1, 50L1 are released into the back space BS. Of the two pairs of speakers 50R, 50L, the pair of speakers 50R disposed at one side or a first side of the lower plate 37 (hereinafter, also referred to as a “right speaker pair 50R”) is provided on the upper surface of the lower plate 37 in a position lying closer to a right end thereof. The pair of speakers 50L disposed at the other side or a second side of the lower plate 37 (hereinafter, also referred to as a “left speaker pair 50L”) is provided on the upper surface of the lower plate 37 in a position lying closer to a left end thereof while being aligned parallel to the right speaker pair 50R in the left-right direction. The speakers 50R, 50L both emit sounds in a sound range which is relatively lower than a sound range of sounds emitted from tweeters 60, which will be described later.

A pair of tweeters (sound-emitting elements) 60 is provided above the keyboard 20 in the back space BS in a position lying forwards and obliquely upwards from the left speaker pair 50L as a first sound-emitting component, and a pair of tweeters (sound-emitting elements) 60 is provided similarly in a position lying forwards and obliquely upwards from the right speaker pair 50R as a second sound-emitting component. In other words, the electronic keyboard instrument 1 includes the four sound-emitting elements or tweeters 60 in total which are disposed at left and right end portions in an inside of the back space BS. Each tweeter 60 functions as a sub-speaker configured to emit sound in a high-pitched sound rage of 1 kHz or higher and is disposed in such a way that a sound-emitting direction thereof is directed substantially towards the front of the main body part 10. In the following description, the pair of tweeters 60 provided at the right end portion in the back space BS is also referred to as a “right tweeter pair 60”, and the pair of tweeters 60 provided at the left end portion in the back space BS is also referred to as a “left tweeter pair 60”. The right tweeter pair 60 and the left tweeter pair 60 are identical components.

The right tweeter pair 60 and the left tweeter pair 60 are disposed in positions which are laterally symmetrical to each other with respect to a central portion of the main body case 30 in the left-right direction and are attached to a lower surface of the front top plate 36F with screws via corresponding third metallic sheets (attachments) 19. The pair of tweeters 60 attached to the single third metallic sheet 19 are disposed close to each other in the left-right direction. As shown in FIGS. 5, 7, and 8, each third metallic sheet 19 has a fixed section 19a configured to be fixed with screws to the lower surface of the front top plate 36F in such a way that the second metallic sheet 16 is held between the lower surface of the front top plate 36F and itself and a pair of attachment sections 19b which extend downwards from a front end portion of the fixed section 19a for attachment of the pair of tweeters 60 thereto. The fixed section 19a extends parallel to the lower surface of the front top plate 36F.

The fixed section 19a is screwed to the front top plate 36F at three locations in total which are two screwing holes H1 provided in positions which are laterally symmetrical on a back side of the fixed section 19a and one screwing hole H2 provided in a central portion in the left-right direction of the fixed section 19a on a front side thereof. As will be described later, the pair of attachment sections 19b extend downwards while also extending obliquely towards the front from the fixed section 19a in a laterally symmetrical fashion so as to match respective sound-emitting directions of the pair of tweeters 60.

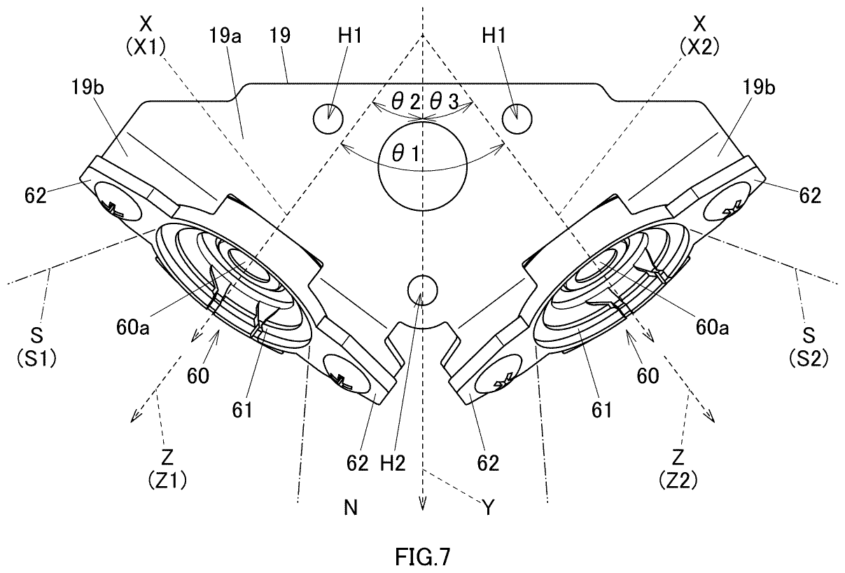

As shown in FIGS. 5, 7, and 8, each tweeter 60 has a tweeter main body 61 having a substantially short cylindrical shape and a pair of protruding sections 62 protruding outwards from a left and right sides of the tweeter main body 61 into a substantially plate shape. The tweeter main body 61 is disposed in such a way that a main sound-emitting direction X thereof is inclined obliquely not only with respect to the front-back direction but also with respect to the up-down direction. A front portion of the tweeter main body 61 is recessed backwards in steps towards an inside thereof to constitute a tweeter sound-emitting section 60a configured to emit sound. The main sound-emitting direction X of each tweeter 60 substantially coincides with an axial direction of the cylindrical tweeter main body 61. When referred to herein, the main sound-emitting direction X denotes a direction in which a sound pressure takes a maximum value within a range S of sound emitted from the tweeter sound-emitting section 60a as shown in FIG. 7.

The pair of tweeters 60 attached to the single third metallic sheet 19 are preferably set to an orientation in which a sound in a high-pitched sound range which has a relatively high directivity is emitted in a wide range, in other words, an orientation in which the range S of sound emitted from each tweeter sound-emitting section 60a becomes wide. To make this happen, as shown in FIGS. 6 and 7, the pair of tweeters 60 are provided at angles at which their main sound-emitting directions X1, X2 are inclined in the left-right direction with respect to a frontal elevation angle direction Y directed to the front of the electronic keyboard instrument 1 and having the same elevation angle (an angle θ4, which will be described later) as an elevation angle of the main sound-emitting direction X. Specifically speaking, of the pair of tweeters 60, one tweeter 60 is provided in such a way that the main sound-emitting direction X thereof is directed towards a center of the main body case 30 in the left-right direction, and the other tweeter 60 is provided in such a way that the main sound-emitting direction X thereof is directed towards an outside of the main body case 30 in the left-right direction. Additionally, in the up-down direction, the pair of tweeters 60 are provided in such a way that the sound-emitting directions X thereof are directed slightly upwards so that their elevation angles form the angle θ4.

The pair of protruding sections 62 are provided in such a way that both plate surfaces thereof are directed obliquely with respect to the front-back direction, so that normal directions of the plate surfaces of the pair of protruding sections 62 substantially coincide with a normal direction of a front plate surface of the corresponding attachment section 19b of the pair of attachment sections 19b of the third metallic sheet 19, as well as the main sound-emitting direction X of the tweeter 60 from which the pair of protruding sections 62 protrude. Each tweeter 60 is attached to the third metallic sheet 19 by the pair of protruding sections 62 being screwed to the corresponding attachment section 19b of the pair of attachment sections 19b of the third metallic sheet 19. That is, each of the pair of tweeters 60 attached to the single third metallic sheet 19 is attached to the third metallic sheet 19 at both sides thereof in the left-right direction.

Here, a mode of arrangement of each tweeter 60 and a specific sound-emitting direction thereof will be described. As shown in FIG. 2, at the right end portion in the interior of the main body case 30, the pair of tweeters 60 attached to the single third metallic sheet 19 are disposed in such a way that a distance W2 which constitutes a distance defined between centers in the left-right direction of the pair of tweeters 60 becomes smaller than a distance W1R which constitutes a distance defined between centers in the left-right direction of the speaker sound-emitting sections 50R1 of the right speaker pair 50R. Similarly, also at the left end portion in the interior of the main body case 30, the pair of tweeters 60 are disposed in such a way that a distance W2 which constitutes a distance defined between centers in the left-right direction of the pair of tweeters 60 becomes smaller than a distance WIL which constitutes a distance defined between centers in the left-right direction of the speaker sound-emitting sections 50L1 of the left speaker pair 50L. Additionally, the right tweeter pair 60 is disposed above the right speaker pair 50R in such a way that the centers of the speaker sound-emitting sections 50R1 both fall between the centers in the left-right direction of the right speaker pair 50R (in FIG. 2, a range defined by the distance W1R) in the left-right direction. The left tweeter pair 60 is disposed above the left speaker pair 50L in such a way that the centers of the speaker sound-emitting sections 50L1 both fall between the centers in the left-right direction of the left speaker pair 50L (in FIG. 2, a range defined by the distance WIL) in the left-right direction.

A center position C2 in the left-right direction of the right tweeter pair 60 is provided closer to the center in the left-right direction of the main body case 30 than a center position CIR in the left-right direction of the right speaker pair 50R. Similarly, a center position C2 in the left-right direction of the left tweeter pair 60 is provided closer to the center in the left-right direction of the main body case 30 than a center position C1L in the left-right direction of the left speaker pair 50L. Here, the right tweeter pair 60 and the left tweeter pair 60 are provided at the same height in the interior of the main body case 30; however, there is provided no particular limitation on a distance defined between the right speaker pair 50R and the right tweeter pair 60 in the up-down direction and on a distance defined between the left speaker pair 50L and the left tweeter pair 60 in the up-down direction.

As shown in FIG. 7, the pair of tweeters 60 attached to the single third attachment 19 are provided in such a way that their main sound-emitting directions form an acute sound-emitting angle in the left-right direction.

Specifically speaking, the pair of tweeters 60 are provided in such a way that an angle θ1 formed in the left-right direction by one main sound-emitting direction X1 and the other main sound-emitting direction X2 constitutes an angle which is smaller than 90 degrees but is larger than 60 degrees, preferably, an angle which is smaller than 78 degrees but is larger than 70 degrees, and more preferably, an angle which is smaller than 75 degrees but is larger than 73 degrees. Sounds emitted from the pair of tweeters 60 are those in a high-pitched sound range and are hence hard to be diffused when compared with sounds in a low-pitched sound range. Here, when the angle θ1 formed in the left-right direction by one main sound-emitting direction X1 and the other main sound-emitting direction X2 exceeds 90 degrees, there may be caused a risk that a range N to which sounds emitted from the pair of tweeters 60 are hard to be propagated is produced between a range S1, which is defined by alternate long and short dash lines, of sound emitted along one main sound-emitting direction X1 from one tweeter sound-emitting section 60a and a range S2, which is defined by alternate long and short dash lines, of sound emitted along the other main sound-emitting direction X2 from the other tweeter sound-emitting section 60a. In addition, when the angle θ1 formed in the left-right direction by one main sound-emitting direction X1 and the other main sound-emitting direction X2 is smaller than 60 degrees, a range where the range S1 of the sound emitted along one main sound-emitting direction X1 from the other tweeter sound-emitting section 60a and the range S2 of the sound emitted along the other main sound-emitting direction X2 from the other tweeter sound-emitting section 60a overlap each other is increased, whereby there may be caused a risk that sounds so emitted from the pair of tweeters 60 are hard to be spread or diffused widely in the left-right direction. Additionally, the pair of tweeters 60 are set in such a way that an angle θ2 formed by one main sound-emitting direction X1 with respect to the frontal elevation angle direction Y and an angle θ3 formed by the other main sound-emitting direction X2 with respect to the frontal elevation angle direction Y are equal. As a result, in the pair of tweeters 60, the main sound-emitting direction X of the inner tweeter 60 is directed towards the center in the left-right direction of the main body case 30 (towards a player), whereas the main sound-emitting direction X of the outer tweeter 60 is directed towards the outside in the left-right direction of the main body case 30 (in such a way as to move away from the player).

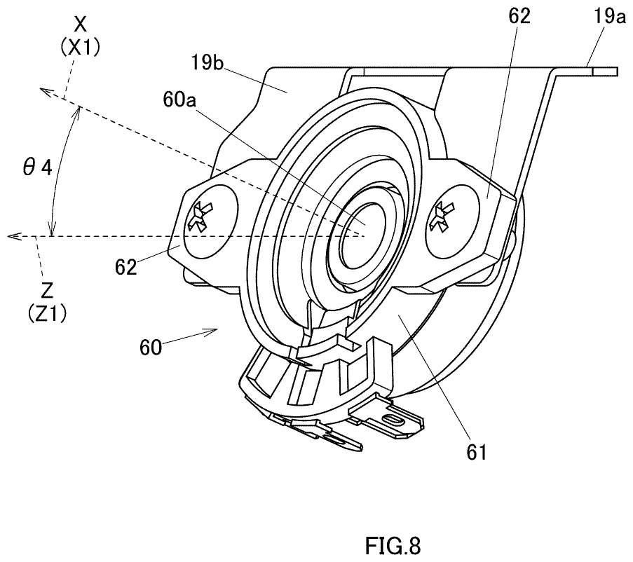

Then, as shown in FIG. 6, the pair of tweeters 60 attached to the single third metallic sheet 19 are provided in an upwardly slightly inclined manner so that their sound-emitting directions in the up-down direction are both directed towards the perforated component 40 (towards the gap defined between the display panel 18 and the front top plate 36F). Specifically speaking, as shown in FIGS. 7 and 8, the pair of tweeters 60 are provided in an upwardly inclined manner such that the main sound-emitting directions X1, X2 which are inclined at the angles θ2, θ3 respectively in the left-right direction with respect to the frontal elevation angle direction Y whose elevation angle is an angle θ4 are inclined at the angles θ2, θ3 respectively in the left-right direction when viewed from above and at angles formed respectively with respect to horizontal axial direction Z1, 22 whose elevation angles in the up-down direction are 0 degree, that is, at the angle θ4 which is the elevation angle falls preferably within an angular range of 10 to 30 degrees, and more preferably within an angular rage of 18 to 22 degrees. Here, the openings 16b are provided individually in the second metallic sheet 16 in a portion lying in front of the right tweeter pair 60 and a portion lying in front of the left tweeter pair 60. Then, the individual holes 40a provided in the perforated component 40 are provided such that their inclination angle in the up-down direction is equal or close to the inclination angle θ4 which is the elevation angle of the pair of tweeters 60 in the up-down direction.

Subsequently, referring to FIGS. 4 and 6, the propagation of sound emitted from each tweeter 60 will be described. Sound emitted from each tweeter 60 travels towards the perforated component 40, passes through the individual holes 40a in the perforated component 40, and travels further towards the outside of the main body case 30 from the gap defined between the display panel 18 and the front top plate 36F. As this occurs, due to the configuration in which the inclination angle of the individual holes 40a in the up-down direction (an inclination angle of an internal wall encompassing each hole 40a) is set equal or close to the inclination angle θ4 of each tweeter 60 in the up-down direction, sound emitted from each tweeter 60 is allowed to pass through the perforated component 40 to reach easily the gap defined between the display panel 18 and the front top plate 36F.

Among the sounds travelling towards the outside of the main body case 30, the sounds emitted towards the center of the main body case 30 in the left-right direction (a sound emitted from one tweeter 60 of the right tweeter pair 60 along the main sound-emitting direction X1 and a sound emitted from one tweeter 60 of the left tweeter pair 60 along the main sound-emitting direction X2) are easy to reach the ears of the player directly because the sound-emitting directions of the tweeters 60 are inclined slightly upwards. On the other hand, among the sounds travelling towards the outside of the main body case 30, the sounds emitted towards the outside of the main body case 30 in the left-right direction (a sound emitted from the other tweeter 60 of the right tweeter pair 60 along the main sound-emitting direction X2 and a sound emitted from the other tweeter 60 of the left tweeter pair 60 along the main sound-emitting direction X1) reach the ears of the player as indirect sound after being reflected, for example, on walls of a room where the electronic keyboard instrument 1 is disposed, and as a result of this, the player can feel a sensation of being or playing, for example, at a real live concert or the like.

In addition, in the present embodiment, although the pair of tweeters 60 attached to the single third metallic sheet 19 are disposed close to each other in the left-right direction, the sound-emitting directions of the pair of tweeters 60 are provided at the different angles in the left-right direction in such a way as to expand or move away from each h other towards the front side, and therefore, an interference of sounds (an interference of a wave of sound emitted from one tweeter 60 with a wave of sound emitted from the other tweeter 60) is hard to occur between the pair of tweeters 60. As a result of this, sounds emitted from the pair of tweeters 60 are made to reach the ears of the player in such a state that the interference of sounds is suppressed.

Subsequently, configurations of other constituent components provided in the front space FS will be described. As shown in FIG. 6, a first support 80 is provided on the front sides of the first metallic sheets 13 in the front space FS. The first support 80 is provided over substantially a whole area of the lower side of the keyboard 20 and is laterally elongated as with the keyboard 20 (refer to FIG. 2). The first support 80 is a hollow component which is opened downwards. The keyboard 20 is supported on the main body case 30 by the first support 80 and a second support 88, which will be described later. The second metallic sheet 16 described above is provided on a back side of the first support 80.

A front end portion of the first support 80 is made into a protuberant or convex section 80a which protrudes upwards into a convex shape. Portions of the first support 80 which are positioned on lower sides of the black keys 22B of the keys 22 are made into a platform section 80b which protrudes upwards into a platform-like shape. A portion of the first support 80 lying between the convex section 80a and the platform section 80b is made into a recessed or concave section 80c which is recessed downwards into a concave shape. Rotatable fulcrum portions 80b1 are provided at a back portion of an upper surface of the platform section 80b so as to support rotatably back end portions of the keys 22 of the keyboard 20. Additionally, a control substrate 85 is provided on the upper surface of the platform section 80b. Switches are provided on the control substrate 85, and when the switches detect the keys 22 which are pressed, the switches output detection signals to produce musical sounds corresponding to the keys 22 so depressed. Multiple concave section openings 80d are provided in the concave section 80c in such a way as to be opened in the front-back direction and the up-down direction, and the multiple concave section openings 80d are aligned side by side in the left-right direction (refer to FIG. 4).

Multiple hammers 84 are provided in a part of a space defined in an inside of the first support 80 which lies below the platform section 80b and are connected with the corresponding keys 22. Each of the hammers 84 includes a substantially triangular weight section 84a and an arm section 84b which extends in a straight line to the front side from the weight section 84a. The arm section 84b is rotatably supported on a pivot 86 provided in a front portion of the space defined in the inside of the platform section 80b. When one of the keys 22 is pressed, the weight section 84a of the corresponding hammer 84 is raised, whereby a feeling of heaviness can be felt by the player when he or she presses the key 22. This can help the player obtain a key press feeling similar to that provided by a real piano.

The second support 88 is disposed on the lower plate 37 and is provided in a portion of the space defined in the inside of the first support 80 which lies further forwards than the portion where the hammers 84 are disposed. The second support 88 is a hollow component which is opened downwards and is attached to the main body case 30 by being screwed down to the lower plate 37. The keyboard 20 is indirectly supported on the main body case 30 made of wood via the first support 80 by the second support 88. The pivot 86 is provided on the second support 88 to support the arm section 84b of the hammer 84.

Subsequently, communication paths P1 to P4 will be described. The communication paths P1 to P4 are provided in the inside of the main body case 30 and constitute sound release paths for sounds emitted from the speakers 50R, 50L. As shown in FIG. 6, in the electronic keyboard instrument 1 according to the present embodiment, four communication paths P1 to P4 are provided in the inside of the main body case 30 as sound release paths along which sounds emitted from the four speakers 50R, 50L are released to eventually reach the outside of the main body case 30. A first communication path P1, which is a first communication path, constitutes a communication path which extends from the four speakers 50R, 50L to reach the front space FS by way of a gap defined between the lower plate 37 and the back attachment 15, then passes underneath the hammers 84 to extend further from the concave section openings 80d to an upper side of the first support 80, and passes through interspaces defined between the keys 22 to eventually reach the outside of the main body case 30.

A second communication path P2, which is a second communication path, constitutes a communication path which extends from the four speakers 50R, 50L to reach the back sides of the first metallic sheets 13 by way of the gap defined between the lower plate 37 and the back attachment 15, then passes around the back sides of the first metallic sheets 13 to extend upwards, and extends further from the attachment openings 14a to eventually reach the outside of the main body case 30. A third communication path P3, which is a third communication path, constitutes a communication path which extends upwards from the four speakers 50R, 50L through the back space BS, then passes sequentially through the holes 40a provided in the perforated component 40, and extends further from the gap G defined between the display panel 18 and the front top plate 36F to eventually reach the outside of the main body case 30. A fourth communication path P4, which is a fourth communication path, constitutes a communication path which extends upwards from the four speakers 50R, 50L through the back space BS to eventually reach the outside of the main body case 30 by way of the upper openings 11a in the cover plate 11. The tweeters 60 are attached in such a way as to be suspended from above by means of the third metallic sheets 19, and hence, there is no need to provide attachment mechanisms below the tweeters 60. Thus, the loss of sounds emitted from the speakers 50R, 50L and released through the third communication path P3 can be suppressed to a lower level.

Thus, as has been described heretofore, the electronic keyboard instrument 1 according to the present embodiment has the main body case 30, the right tweeter pair 60 provided at the right side of the main body case 30 and having the multiple sound-emitting elements whose the main sound-emitting directions differ from each other, and the left tweeter pair 60 provided at the left side of the main body case 30 and having the multiple sound-emitting elements whose the main sound-emitting directions differ from each other. Further, in the electronic keyboard instrument 1 according to the present embodiment, each of the right tweeter pair 60 and the left tweeter pair 60 is provided at the different angles in the left-right direction so that their sound-emitting directions expand or move away from each other towards the front side.

With the electronic keyboard instrument 1 according to the present embodiment, which is configured described above, in each of the right tweeter pair 60 and the left tweeter pair 60, the interference of sounds can be prevented from occurring between the pair of tweeters 60, thereby allowing sounds emitted from the pair of tweeters 60 to reach the player effectively. As a result, the acoustic effect of the electronic keyboard instrument 1 can be enhanced.

With the electronic keyboard instrument 1 according to the present embodiment, each of the right tweeter pair 60 and the left tweeter pair 60 is configured such that one or a first sound-emitting direction is directed towards the outside of the main body case 30 in the left-right direction and the other or a second sound-emitting direction is directed towards the center of the main body case 30 in the left-right direction. According to this configuration, a sound emitted from one of the pair of tweeters 60 can be made into direct sound which reaches the player directly, and a sound emitted from the other tweeter can be made into indirect sound which reaches the player indirectly, whereby the acoustic effect of the electronic keyboard instrument can be enhanced further.

With the electronic keyboard instrument 1 according to the present embodiment, each of the right tweeter pair 60 and the left tweeter pair 60 is configured such that the main sound-emitting direction of one tweeter and the main sound-emitting direction of the other tweeter form the angle which is smaller than 90 degrees but is larger than 60 degrees in the left-right direction. Here, in the case that the angle formed in the way described above is larger than 90 degrees, a sufficient quantity of sound cannot be secured between the pair of tweeters 60. On the other hand, in the case that the angle formed in the way described above is smaller than 60 degrees, the interference of sounds between the pair of tweeters 60 cannot be suppressed sufficiently. According to the configuration described above, a specific sound-emitting angle in the left-right direction can be provided which can suppress the interference of sounds while securing the sufficient quantity of sound.

With the electronic keyboard instrument 1 according to the present embodiment, each of the right tweeter pair 60 and the left tweeter pair 60 is configured in an upwardly inclined manner in an up-down direction. According to this configuration, the sound-emitting directions of the pair of tweeters 60 are directed to the height of the ears of the player, and hence, sounds emitted from the pair of tweeters 60 can be directed towards the player effectively.

With the electronic keyboard instrument 1 according to the present embodiment, each of the right tweeter pair 60 and the left tweeter pair 60 is configured in an upwardly inclined manner such that an angle formed in an up-down direction by main sound-emitting directions with respect to a front-back direction of the main body case 30 falls within a range of 10 to 30 degrees. According to this configuration, a specific sound-emitting angle in the up-down direction can be provided because the sound-emitting directions of the pair of tweeters 60 are directed to the height of the ears of the player.

With the electronic keyboard instrument 1 according to the present embodiment, the speakers 50R, 50L include the left speaker pair 50L provided at the left side within the main body case 30 in the left-right direction and configured to emit mainly sounds in the low-pitched and mid-pitched sound ranges and the right speaker pair 50R provided at the other side within the main body case 30 in the left-right direction and configured to emit sounds in the high-pitched sound range. The pair of tweeters 60 is provided above the left speaker pair 50L, and the pair of tweeters 60 is provided above the right speaker pair 50R. According to this configuration, sounds emitted from the left speaker pair 50L and sounds emitted from the left tweeter pair 60 can be combined together at the left end portion in the main body case 30 (allowing the sounds so emitted to be heard as a sound emitted from the same sound-emitting location or source). Similarly, sounds emitted from the right speaker pair 50R and sounds emitted from the right tweeter pair 60 can be combined at the right end portion in the main body case 30. As a result, the acoustic effect of the electronic keyboard instrument 1 can be enhanced.

With the electronic keyboard instrument 1 according to the present embodiment, the distance W2 defined in the left-right direction of the left tweeter pair 60 is smaller than the distance WIL defined in the left-right direction of the left speaker pair 50L. Similarly, the distance W2 defined in the left-right direction of the right tweeter pair 60 is smaller than the distance W1R defined in the left-right direction of the right speaker pair 50R. According to this configuration, sounds emitted from the tweeters 60 of the left tweeter pair 60 are made to be heard as a sound emitted as from the same sound-emitting location or source in such a way as to be diffused radially, and sounds emitted from the tweeters 60 of the right tweeter pair 60 are made to be heard as natural sounds.

With the electronic keyboard instrument 1 according to the present embodiment, the left tweeter pair 60 is provided above the left speaker pair 50L in such a way as to be accommodated or fall within the range of the distance W1L defined in the left-right direction of the left speaker pair 50L. Similarly, the right tweeter pair 60 is provided above the right speaker pair 50R in such a way as to be accommodated or fall within the range of the distance W1R defined in the left-right direction of the right speaker pair 50R. According to this configuration, sounds in the high-pitched sound range emitted from the left tweeter pair 60 and sounds in the low-pitched and mid-pitched sound ranges emitted from the left speaker pair 50L are made to be heard naturally without causing the player to feel any sense of incongruity as sounds emitted as from the same sound-emitting location or source. Similarly, mainly sounds in the high-pitched sound range emitted from the right tweeter pair 60 and sounds in the low-pitched and mid-pitched sound ranges emitted from the right speaker pair 50R are made to be heard naturally without causing the player to feel any sense of incongruity as sounds emitted as from the same sound-emitting location or source.

With the electronic keyboard instrument 1 according to the present embodiment, the center position in the left-right direction between one or a first side and the other or a second side of the left tweeter pair 60 is provided closer to the center of the main body case 30 in the left-right direction than the center position in the left-right direction between one or a first side and the other or a second side of the left speaker pair 50L. Similarly, the center position in the left-right direction between one or a first side and the other or a second side of the right tweeter pair 60 is provided closer to the center of the main body case 30 in the left-right direction than the center position in the left-right direction between one or a first side and the other or a second side of the right speaker pair 50R. According to this configuration, the left tweeter pair 60 and the right tweeter pair 60 are disposed closer to the center of the main body case 30 in the left-right direction, that is, closer to the player, and hence, sounds emitted from the tweeters 60 are allowed to easily reach the ears of the player.

With the electronic keyboard instrument 1 according to the present embodiment, the left tweeter pair 60 and the right tweeter pair 60 are attached individually to the main body case 30 via the corresponding third metallic sheets 19. According to this configuration, the component for attaching the left tweeter pair 60 to the main body case 30 and the component for attaching the right tweeter pair 60 to the main body case 30 can be made common to each other, thereby making it possible not only to simplify the production process of the electronic keyboard instrument 1 but also to reduce the manufacturing costs thereof.

With the electronic keyboard instrument 1 according to the present embodiment, each of the left tweeter pair 60 and the right tweeter pair 60 is attached to the third metallic sheet 19 at both sides thereof in the left-right direction. For each tweeter 60, in the case that the tweeter 60 is attached to the third metallic sheet 19 at both upper and lower sides thereof, there may be caused a risk that the upper and lower sides of the tweeter 60 collide with the front top plate 36F (the second metallic sheet 16) and the display panel 18, and this may impose a limitation to the arrangement of the tweeter 60 in the up-down direction. In addition, there may be caused a risk that the loss of sounds emitted from the speakers 50R, 50L and released through the third communication path P3 is increased. In contrast with this, according to the present embodiment, the tweeters 60 can be provided in the inside of the main body case 30 without any limitation on the arrangement of the tweeters 60 in the up-down direction, and sounds emitted from f the speakers 50R, 50L can be released well to the outside of the main body case 30. The electronic musical instrument is described as the example to which the present disclosure can be applied in the present embodiment; however, the present disclosure is not limited thereto, and hence, the present disclosure can also be applied to other audio equipment including a stereo component system in addition to musical instruments.

In the present disclosure, unless explicitly stated, the term ‘at least’ includes multiple combinations or a number equal to or larger than a number designated so that for example, the term ‘at least one of A, B and C’ means ‘(A), (B), (C), (A and B), (A and C), (B and C), or (A, B and C)’. In addition, in the case that C is plural, the phrase ‘at least one of A, B and C’ means ‘(A), (B), (at least one C), (A and B), (A and at least C), (B and at least one C), or (A, B and at least one C)’. The same will also be true in the case that A is plural or in the case that B is plural.

In the present disclosure, unless explicitly stated, the term ‘or’ is used when a non-exclusive matter (thing) is mentioned so that for example, the term ‘A or B’ means ‘any of (A but not B), (B but not A), and (A and B)’.

In the present disclosure, terms such as ‘first’, ‘second’ and ‘third’ are used to simply distinguish them from others for convenience in description, and hence, any specific order (in terms of, for example, space, time, and logic) is not given to those numbers, unless explicitly stated.

In the present disclosure, terms ‘one’ and ‘the other’ denote matters or things which are different from each other, and unless explicitly stated, ‘one’ described earlier and ‘one’ described later do not necessarily denote the same matter or thing. Similarly, ‘the other’ described earlier and ‘the other’ described later do not necessarily denote the same matter or thing.

Here, the embodiment of the present disclosure that has been described heretofore is presented as the example, and hence, there is no intention to limit the scope of the present disclosure by the embodiment. The novel embodiment can be carried out in other various forms, and various omissions, replacements, and modifications can be made thereto without departing from the spirit and scope of the present disclosure. Those resulting embodiments and modified examples thereof are included in the scope and gist of the present disclosure and are also included in the scope of disclosures claimed for patent under claims below and their equivalents.

What is claimed is:

1. An electronic apparatus comprising:
a housing;
a first sound-emitting component provided at a first side in a left-right direction of the housing and comprising multiple sound-emitting elements whose main sound-emitting directions differ from each other; and
a second sound-emitting component provided at a second side in the left-right direction of the housing and comprising multiple sound-emitting elements whose main sound-emitting directions differ from each other.

2. The electronic apparatus according to claim 1,
wherein each of the multiple sound-emitting elements of at least one of the first sound-emitting component and the second sound-emitting component is configured such that their respective main sound-emitting directions form different angles with respect to the left-right direction.

3. The electronic apparatus according to claim 1,
wherein the multiple sound-emitting elements of the first sound-emitting component constitute a pair of sound-emitting elements, and the multiple sound-emitting elements of the second sound-emitting component constitute a pair of sound-emitting elements, and
wherein each of the pair of sound-emitting elements of at least one of the first sound-emitting component and the second sound-emitting component is configured such that a main sound-emitting direction of a first sound-emitting element is directed towards a center of the housing in the left-right direction and a main sound-emitting direction of a second sound-emitting element is directed to an outside of the housing in the left-right direction.

4. The electronic apparatus according to claim 1,
wherein the multiple sound-emitting elements of the first sound-emitting component constitute a pair of sound-emitting elements, and the multiple sound-emitting elements of the second sound-emitting component constitute a pair of sound-emitting elements, and
wherein each of the pair of sound-emitting elements of at least one of the first sound-emitting component and the second sound-emitting component is configured such that an angle formed in the left-right direction by a main sound-emitting direction of a first sound-emitting element and a main sound-emitting direction of a second sound-emitting element constitutes an angle which is smaller than 90 degrees but is larger than 60 degrees.

5. The electronic apparatus according to claim 4,
wherein each of the pair of sound-emitting elements of at least one of the first sound-emitting component and the second sound-emitting component is configured in an upwardly inclined manner such that an angle formed in an up-down direction by sound-emitting directions with respect to a front-back direction of the housing falls within a range of 10 to 30 degrees.

6. The electronic apparatus according to claim 4, further comprising:
a third sound-emitting component configured to emit a sound in a sound range which is lower than a sound range of at least one of the first sound-emitting component and the second sound-emitting component.

7. The electronic apparatus according to claim 1,
wherein each of the multiple sound-emitting elements of at least one of the first sound-emitting component and the second sound-emitting component is configured in an upwardly inclined manner in an up-down direction.

8. The electronic apparatus according to claim 1,
wherein the multiple sound-emitting elements of the first sound-emitting component constitute a pair of sound-emitting elements, and the multiple sound-emitting elements of the second sound-emitting component constitute a pair of sound-emitting elements, and
wherein each of the pair of sound-emitting elements of at least one of the first sound-emitting component and the second sound-emitting component is configured in an upwardly inclined manner such that an angle formed in an up-down direction by sound-emitting directions with respect to a front-back direction of the housing falls within a range of 10 to 30 degrees.

9. The electronic apparatus according to claim 8, further comprising:
a third sound-emitting component configured to emit a sound in a sound range which is lower than a sound range of at least one of the first sound-emitting component and the second sound-emitting component.

10. The electronic apparatus according to claim 1, further comprising:
a third sound-emitting component configured to emit a sound in a sound range which is lower than a sound range of at least one of the first sound-emitting component and the second sound-emitting component.

11. The electronic apparatus according to claim 10,
wherein the third sound-emitting component comprises a first pair of sound-emitting elements provided at a first side in the left-right direction and a second pair of sound-emitting elements provided at a second side in the left-right direction in an inside of the housing.

12. The electronic apparatus according to claim 11,
wherein the multiple sound-emitting elements of the first sound-emitting component constitute a pair of sound-emitting elements, and the multiple sound-emitting elements of the second sound-emitting component constitute a pair of sound-emitting elements, and
wherein a distance defined in the left-right direction between the pair of sound-emitting elements of at least one of the first sound-emitting component and the second sound-emitting component is smaller than at least one of a distance defined in the left-right direction between the first pair of sound-emitting elements of the third sound-emitting component and a distance defined in the left-right direction between the second pair of sound-emitting elements of the third sound-emitting component.

13. The electronic apparatus according to claim 1,
wherein the multiple sound-emitting elements of the first sound-emitting component constitute a pair of sound-emitting elements, and the multiple sound-emitting elements of the second sound-emitting component constitute a pair of sound-emitting elements, and
wherein when viewed from above, one of the first sound-emitting component and the second sound-emitting component is situated between a first position and a second position of the pair of sound-emitting elements provided at a first side in the left-right direction, and when viewed from above, a remaining one of the first sound-emitting component and the second sound-emitting component is situated between a first position and a second position of the pair of sound-emitting elements provided at a second side in the left-right direction.

14. The electronic apparatus according to claim 1,
wherein the multiple sound-emitting elements of the first sound-emitting component constitute a pair of sound-emitting elements, and the multiple sound-emitting elements of the second sound-emitting component constitute a pair of sound-emitting elements, and
wherein at least one of a center position in the left-right direction of the first sound-emitting component and a center position in the left-right direction of the second sound-emitting component is situated closer to a center in the left-right direction of the housing than at least one of a center position of the pair of sound-emitting elements provided at a first side in the left-right direction and a center position of the pair of sound-emitting elements provided at a second side in the left-right direction.

15. The electronic apparatus according to claim 1,
wherein the first sound-emitting component and the second sound-emitting component are attached to the housing via respective single attachments that differ from each other.

16. The electronic apparatus according to claim 15,
wherein the multiple sound-emitting elements of the first sound-emitting component are attached individually to a single attachment, and the multiple sound-emitting elements of the second sound-emitting component are attached individually to a single attachment which is different from the single attachment used for the first sound-emitting component.
